(19) United States
(12) Patent Application Publication
(10) Pub. No.: US 2014/0118824 A1
(43) Pub. Date: May 1, 2014

(54) THREE DIMENSIONS DISPLAY DEVICE AND DISPLAYING METHOD THEREOF

(71) Applicant: AU OPTRONICS CORP., Hsin-Chu (TW)

(72) Inventors: Yi-San HSIEH, Hsin-Chu (TW); Yung-Sheng TSAI, Hsin-Chu (TW); Jen-Lang TUNG, Hsin-Chu (TW)

(21) Appl. No.: 13/939,296

(22) Filed: Jul. 11, 2013

(30) Foreign Application Priority Data
Oct. 26, 2012 (TW) 101139791

(51) Int. Cl. G02B 27/22

(52) U.S. Cl. CPC G02B 27/2214
USPC 359/464

(57) ABSTRACT

An autostereoscopic display device including a display panel, a parallax barrier and a control module is provided. The display panel has a display surface and includes a plurality of first sub-pixel units and a plurality of second sub-pixel units alternately arranged with each other. The parallax barrier is arranged at a side of the display surface and includes a plurality of barrier units. Each barrier unit includes 1st to Nth gratings, wherein N is an odd number larger than 1. The controlling module is electrically coupled to the display panel and the parallax barrier, and used for controlling the parallax barrier and images displayed by the first sub-pixel units and the second sub-pixel units. A displaying method of the autostereoscopic display device is also disclosed.

### TECHNICAL FIELD

The invention relates to a three dimensions display device, in particularly to a naked eye three dimensional display device and a displaying method thereof.

### BACKGROUND

The display technology of three dimensional (3D) can be categorized into stereoscopic and autostereoscopic. A viewer can directly view 3D images from the autostereoscopic display without wearing a glasses or a helmet. Apparently, the autostereoscopic display more satisfies the requirements to natural vision of human beings than the stereoscopic display devices.

The autostereoscopic display has a part of pixels providing left eye images for the viewer's left eye and another part of pixels providing right eye images for the viewer's right eye. The two parts of pixels can be arranged in a sequential manner. And, a parallax barrier with a plurality of opaque stripes is arranged between the display panel and the viewer for shielding certain regions of an image provided by the pixels. Therefore, the viewer's left eye only can view the left eye images and the viewer's right eye only can view the right eye images. As a result, a three dimensional image is consequently formed in the viewer's brain.

However, while viewing the autostereoscopic display, the position relationship between the viewer and the parallax barrier is crucial. An inappropriate position relationship may cause the right/left eyes of the viewer to receive excessive brightness of the left/right eye images, and the three-dimensional image information in the brain is doubled. Such a phenomenon is called crosstalk. Therefore, there is a preferred viewing angle for watching the autostereoscopic display. When the viewer watches the autostereoscopic display in the preferred viewing angle, the images through the parallax barrier can be accurately viewed by the viewer's left and right eyes, respectively, with minimized crosstalk.

In order to solve the problem of the crosstalk, a conventional approach is to enlarge the shielding region of the parallax barrier, such that light leakage of right/left eye images viewed by the left eye/right eye of the viewer can be decreased, and the preferred viewing angle for the right eye/left eye of the viewer can be expanded. However, while the shielding region of the parallax barrier is enlarged, the image brightness of the autostereoscopic display is decreased. Another conventional approach is to provide a parallax barrier having a plurality of gratings. Some of the gratings are transparent, while other gratings are opaque. The viewer's right/left eye can see through the transparent gratings to view the right/left images. However, the manufacturing process of the parallax barrier having the gratings is more complicated, and the cost is higher.

Therefore, how to eliminate the crosstalk ratio of the viewing angles under the conditions that the image brightness and the manufacturing cost of the autostereoscopic display are not affected is a major developing subject in this industry.

### SUMMARY

The embodiments of the invention provide an autostereoscopic display including a display panel, a parallax barrier and a control module. The display panel includes a plurality of first sub-pixel units and a plurality of second sub-pixel units alternately arranged with each other. Moreover, the display panel has a display surface. The parallax barrier is arranged at a side of the display surface and includes a plurality of barrier units, each of the barrier units includes 1st to Nth transparency-adjustable gratings, wherein N is an odd number larger than 1. The control module is electrically coupled to the display panel and the parallax barrier, and configured to control the parallax barrier and images displayed by the first sub-pixel units and the second sub-pixel units.

The embodiments of the invention also provide a displaying method of the above-mentioned autostereoscopic display. The displaying method including: controlling the transparency of the gratings of each of the barrier units for changing a grating of the barrier units at a first position to be opaque for providing a three dimensional image of a first viewing angle while displaying a first image by the first sub-pixel units and displaying a second image by the second sub-pixel units; and remaining the grating of the barrier units at the first position in the opaque status, and displaying the second image by the first sub-pixel units, and displaying the first image by the second sub-pixel units while displaying a first image by the first sub-pixel units and displaying a second image by the second sub-pixel units.

The embodiments of the invention also provide an autostereoscopic display for providing a plurality of three dimensional images in different viewing angle. The autostereoscopic display including a display panel, a parallax barrier and a control module. The display panel includes a plurality of first sub-pixel units and a plurality of second sub-pixel units alternately arranged with each other. And, the display panel has a display surface. The parallax barrier is arranged at a side of the display surface and includes a plurality of barrier units, each of the barrier units includes 1st to Nth transparency-adjustable gratings, wherein N is odd number larger than 1. Each of the gratings has an adjustable transparency. The control module is electrically coupled to the display panel and configured to control the transparency of the gratings of each of the barrier units to make the grating of the barrier units at a first position in a transparent status while the first sub-pixel units displaying a first image and the second sub-pixel units displaying a second image to provide a three dimensional image in a first viewing angle. Further, the control module is configured to control the parallax barrier to remain the grating of the barrier units in the first position in the transparent status while the first sub-pixel units displaying the second image and the second sub-pixel units displaying the first image to provide a three dimensional image in a second viewing angle is provided.

### BRIEF DESCRIPTION OF THE DRAWINGS

The present invention will become more readily apparent to those ordinarily skilled in the art after reviewing the following detailed description and accompanying drawings, in which:

FIG. 1 is a cross-sectional schematic view of an autostereoscopic display according to an embodiment of the present invention;

FIG. 2A is a schematic view of a parallax barrier according to another embodiment of the present invention;

FIG. 2B is a schematic view of a parallax barrier according to another embodiment of the present invention;

FIG. 3 to FIG. 8 are partially cross-sectional schematic views of an autostereoscopic display displaying three dimensional images according to an embodiment of the present invention;

FIG. 9A to FIG. 9F are schematic views showing equivalent grating arrangement in various viewing angles of the parallax barrier of the autostereoscopic display shown in FIG. 1;

FIG. 10A to FIG. 10J are schematic views showing equivalent grating arrangement in various viewing angles of the parallax barrier of the autostereoscopic display according to another embodiment.

FIG. 11A to FIG. 11D are schematic views showing equivalent grating arrangement in various viewing angles of the parallax barrier with even number of gratings of the display.

### DETAILED DESCRIPTION OF PREFERRED EMBODIMENTS

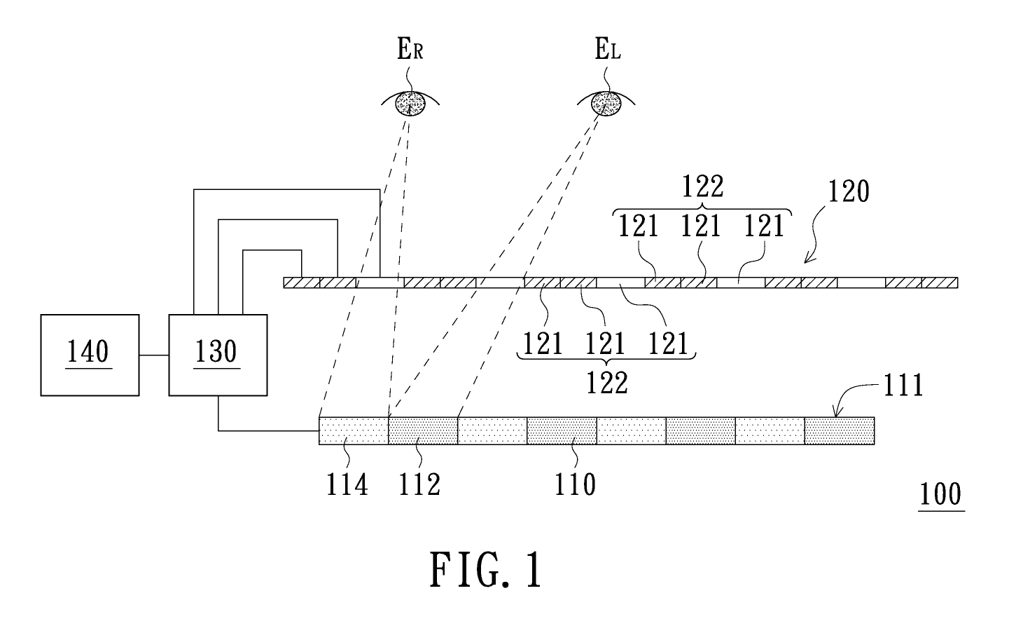

FIG. 1 is a cross-sectional schematic view of an autostereoscopic display according to an embodiment of the present invention. The autostereoscopic display includes a display panel 110, a parallax barrier 120 and a control module 130. The display panel 110 includes a plurality of first sub-pixel units 112, and a plurality of second sub-pixel units 114. The first sub-pixel units 112 and the second sub-pixel units 114 are alternately arranged. In this embodiment, the first sub-pixel units 112 are used for displaying a first image I_{L}, and the second sub-pixel units 114 are used for displaying a second image I_{R}. Hereinafter, the first image I_{L} and the second image I_{R} are displayed on a display surface 111 of the display panel 110.

In this embodiment, the first image I_{L} is the image for the left eye of a viewer, and the second image I_{R} is the image for the right eye of a viewer. A three dimensional display image is formed in the brain of the viewer based on the images viewed by the left and right eyes.

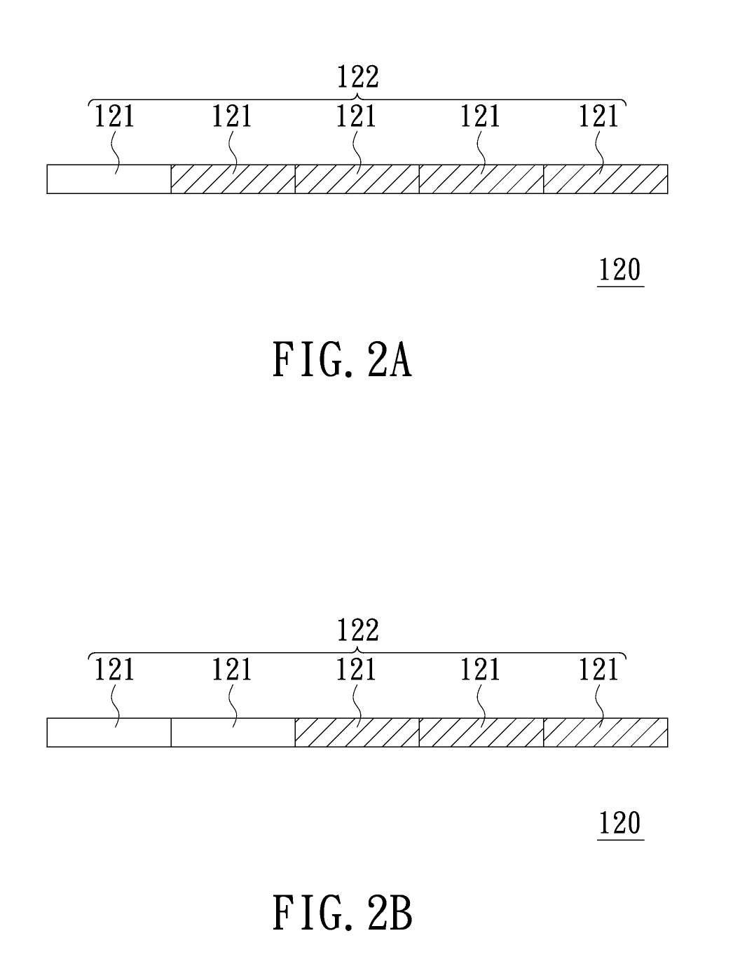

The parallax barrier 120 is disposed at a side of the display surface 111, and the parallax barrier 120 includes a plurality of barrier units 122. Each of the barrier units 122 includes 1st to Nth number of gratings 121 arranged sequentially. The transparencies of the gratings are adjustable. And the number N is odd and larger than 1. In this embodiment, the N number is 3, but the invention is not limited hereto. Besides, the gratings 121 have the same width W. In this embodiment, each of the barrier units 122 has two opaque gratings 121 (the grids with inclined stripe pattern) and a transparent grating 121 (the blank grid). In other words, each of the barrier units 122 has a light-shielding ratio of 66.67%, but the invention is not limited hereto. In other embodiments, the number of the transparent grating 121 and the number of the opaque grating 121 can be decided according to practical demand. For example, in other embodiment, when N is equal to 5, each of the barrier unit 122 has a transparent grating 121 and four opaque grating 121(as shown in FIG. 2A), or two transparent grating 121 and three opaque grating 121(as shown in FIG. 2B). Generally speaking, the number ratio of the opaque grating 121 and the transparent grating 121 is equal to or large than 60%.

Referring to FIG. 1, the control module 130 is electrically coupled to the display panel 110 for controlling the images displayed by the first sub-pixel units 112 and the second sub-pixel units 114 of the display panel 110. Besides, the control module 130 is also electrically coupled to the parallax barrier 120, for controlling the transparency of the gratings 121 of each of the barrier unit 122. In particularly, in each of the barrier units 122 of the parallax barrier 120 in this embodiment, each of the grating 121 is individually and electrically coupled to the control module 130. In other words, the control module 130 of the embodiment can control the transparency of each of the gratings 121.

Besides, the autostereoscopic display 100 may further includes a detecting module 140 configured to detect the position of viewer. The detecting module 140 is electrically coupled to the control module 130 for transmitting the position information of viewer to the control module 130. More specifically, the detecting module 140 is an image sensing device, such as a charge couple device (CCD) or a complementary metal-oxide-semiconductor (CMOS), but the invention is not limited hereto.

The control module 130 can control at least one of the display panel 110 and the parallax barrier 120. More specifically, the detecting module 140 can detect the position of the viewer and transmit it to the control module 130. Then the control module 130 can adjust the transparency of each or some of the gratings 121 of the parallax barrier 120 according to the distance between the viewer and the display panel 110 and the distance between the viewer's eyes. The present invention will now be described more specifically with reference to the following embodiments.

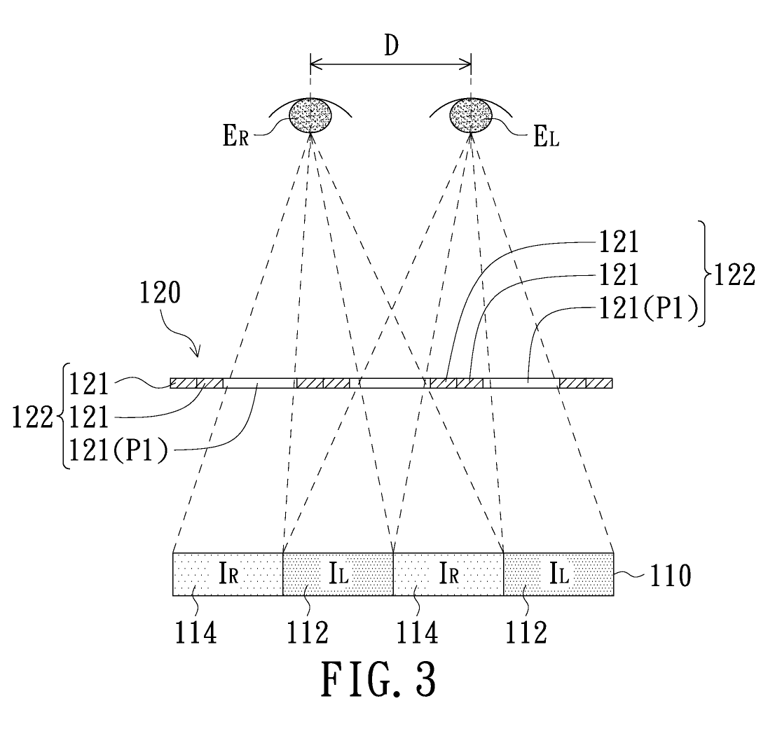

FIG. 3 to FIG. 8 are partially cross-sectional views of an autostereoscopic display according to an embodiment of the invention.

As FIG. 1 and FIG. 3 show, in the embodiment, the distance between the left eye E_{L} and right eye E_{R} of a viewer is denoted as D. When the position of viewer in FIG. 3 is detected by the detecting module 140, the control module 130 controls the first sub-pixel units 112 and the second sub-pixel units 114 of the display panel 110 to respectively show a first image I_{L} and a second image I_{R}, and controls the grating 121 located at a corresponding position P1 (the right side grating 121 of each of the barrier units 122) of each of the barrier unit 122 to be in a transparent status and controls the rest two gratings 121 to be in an opaque status. At the time, the left eye E_{L} and right eye E_{R} of the viewer respectively see the first sub-pixel units 112 and the second sub-pixel units 114 through the transparent gratings 121, then a three dimensional image of a first viewing angle is formed by the first image I_{L} and the second image I_{R} in the brain of the viewer.

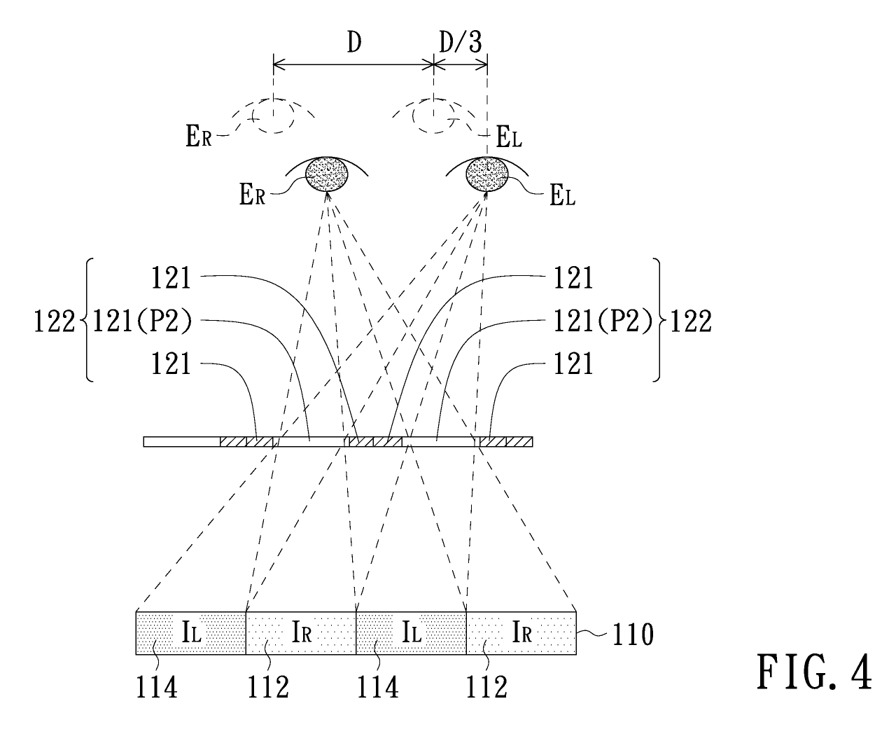

As FIG. 1 and FIG. 4 show, when the detecting module 140 detects a movement of D/3 of the viewer toward the right direction in the drawing, the control module 130 controls the transparency of the gratings 121 of the barrier unit 122. Specifically, the control module 130 controls the grating 121 at a corresponding position P2 (the middle grating 121 of each of the barrier units 122) to be in a transparent status and controls the two side grating 121 to be in an opaque status. At the time, the viewer's left eye E_{L} sees the images mostly displayed by the second sub-pixel units 114, and the viewer's right eye E_{R} sees the images mostly displayed by the first sub-pixel units 112. In order to reduce the crosstalk, the control module 130 is used to control the display panel 110 for displaying the second image I_{R} by the first sub-pixel units 112 and displaying the first image I_{L} by the second sub-pixel units 114. In other words, the images displayed by the first sub-pixel units 112 and the second sub-pixel units 114 are exchanged with each other, so that the viewer's left eye E_{L} and right eye E_{R} can respectively see the accurate images, and an accurate three dimensional image is formed in the brain of the viewer. In other words, the second sub-pixel units 114 for providing images to right eye E_{R} as shown in FIG. 3 is now used for providing images to the left eye E_{L}. Similarly, the first sub-pixel units 112 for providing images to left eye E_{L} as shown in FIG. 3 is now used for providing images to the right eye E_{R}.

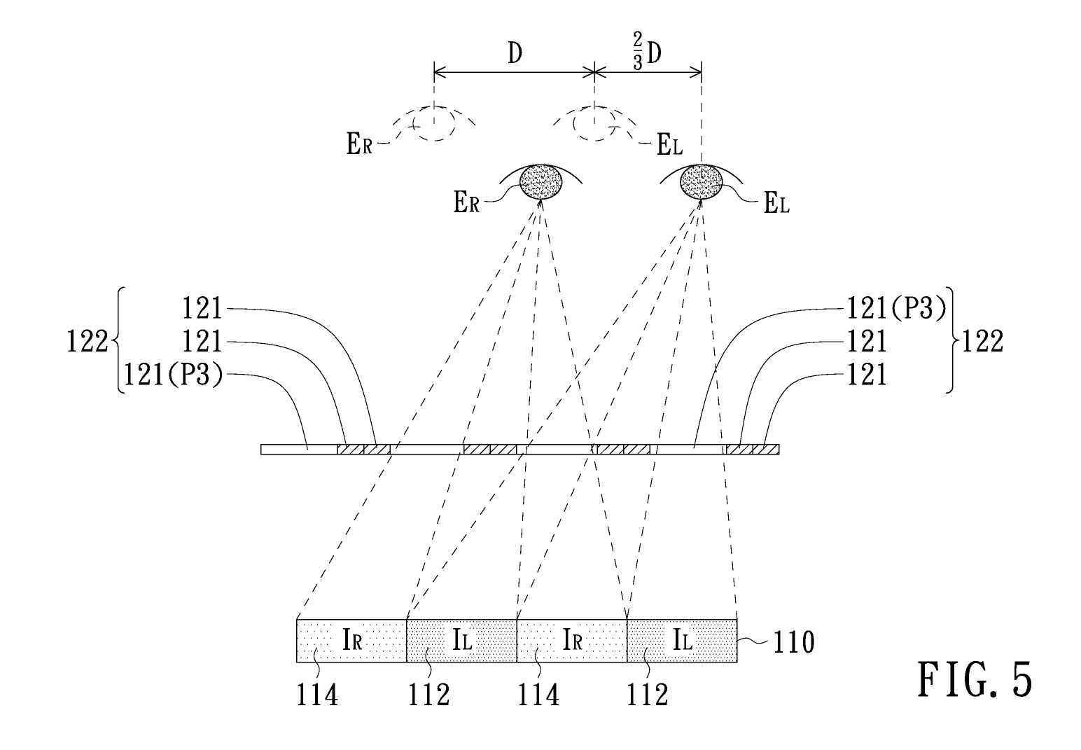

As shown in FIG. 1 and FIG. 5, when the detecting module 140 detects a movement of 2D/3 of the viewer toward the right direction in the drawing, the control module 130 can be used to control the transparency of the gratings 121 of the barrier unit 122. Specifically, the control module 130 controls the grating 121 at a corresponding position P3 (the left side grating 121 of each of the barrier units 122) to be in a transparent status and controls the other two gratings 121 in an opaque status. The viewer's left eye E_{L} sees the first images I_{L} displayed by the first sub-pixel units 112, and the viewer's right eye E_{R} sees the second images I_{R} displayed by the second sub-pixel units 114, and an accurate three dimensional image is formed in the brain of the viewer. In other words, the second sub-pixel units 114 are now used for providing images to right eye E_{R}. Similarly, the first sub-pixel units 112 are now used for providing images to left eye E_{L}.

As shown in FIG. 1 and FIG. 6, when the detecting module 140 detects a movement of D of the viewer toward the right direction in the drawing, the control module 130 is used to control the grating 121 at a corresponding position P1 in a transparent status and also controls the other two gratings 121 in an opaque status. The control module 130 also controls the first sub-pixel units 112 to show the second images I_{R}, and controls the second sub-pixel units 114 to show the first images I_{L} to provide a three dimensional image in a second viewing angle. In other words, when the distance of the movement of the viewer is equal to the distance D between the eyes, the display images of the first sub-pixel units 112 and the second sub-pixel units 114 can be exchanged, so that the viewer's left eye E_{L} and right eye E_{R} can respectively see the first image I_{L} and the second image I_{R}, and then an accurately three dimensional image can be formed in the brain of the viewer. In other words, the position of the transparent grating 121 of the barrier unit 122 in the embodiment is the same as the barrier unit 122 in FIG. 3, but the second sub-pixel units 114 used for providing images for the right eye E_{R} in FIG. 3 is now used for providing images for the left eye E_{L}, and the first sub-pixel units 113 used for providing images for the left eye E_{L} in FIG. 3 is now used for providing images for the right eye E_{R}.

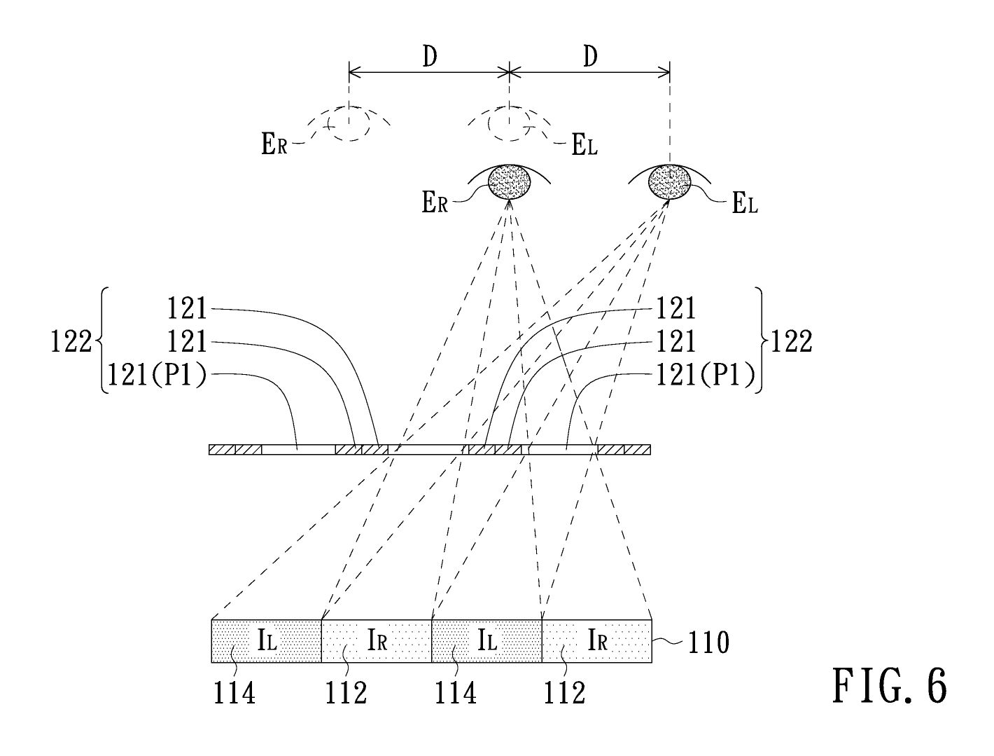

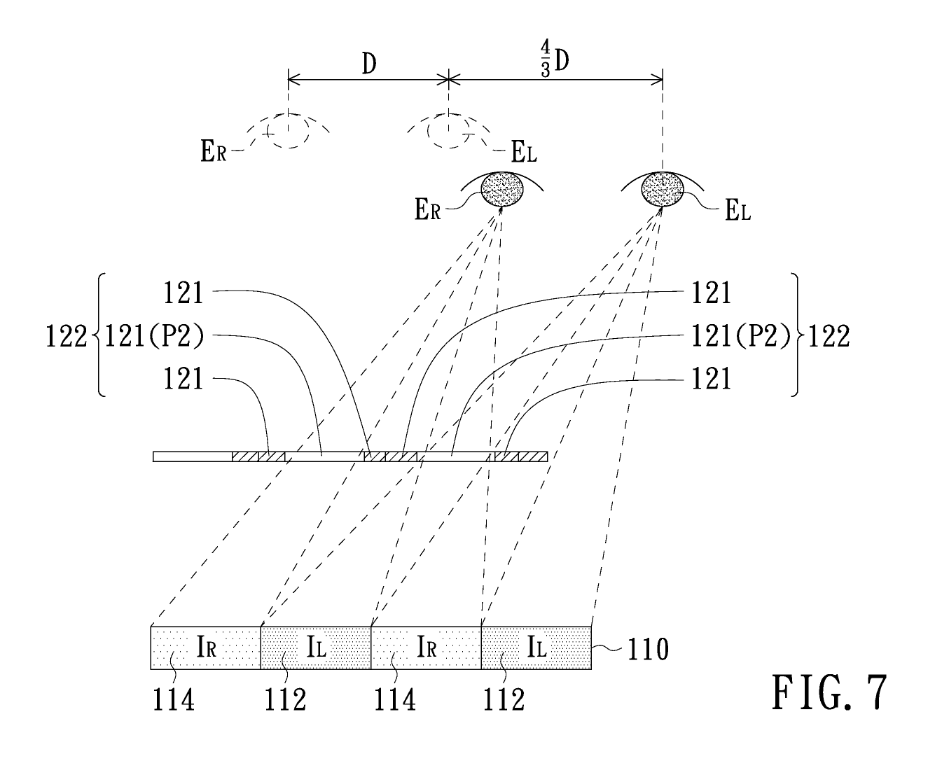

As shown in FIG. 1 and FIG. 7, when the detecting module 140 detects a movement of 4/3D of the viewer toward the right direction in the drawing, the control module 130 is used to control the grating 121 of each of the barrier unit 122. Specifically, the control module 130 controls the grating 121 at a corresponding position P2 to be in a transparent status and controls the other two gratings 121 to be in an opaque status. The viewer's left eye E_{L} and right eye E_{R} can respectively see the first image I_{L} displayed by the first sub-pixel units 112 and the second image I_{R} displayed by the second sub-pixel units 114, and then an accurately three dimensional image is formed in the brain of the viewer. In other words, the position of the transparent grating 121 of the barrier unit 122 in the embodiment is the same with the barrier unit 122 in FIG. 4. The difference is that the second sub-pixel units 114 is now used for providing images for the right eye E_{R}, and the first sub-pixel units 113 is now used for providing images for the left eye E_{L}.

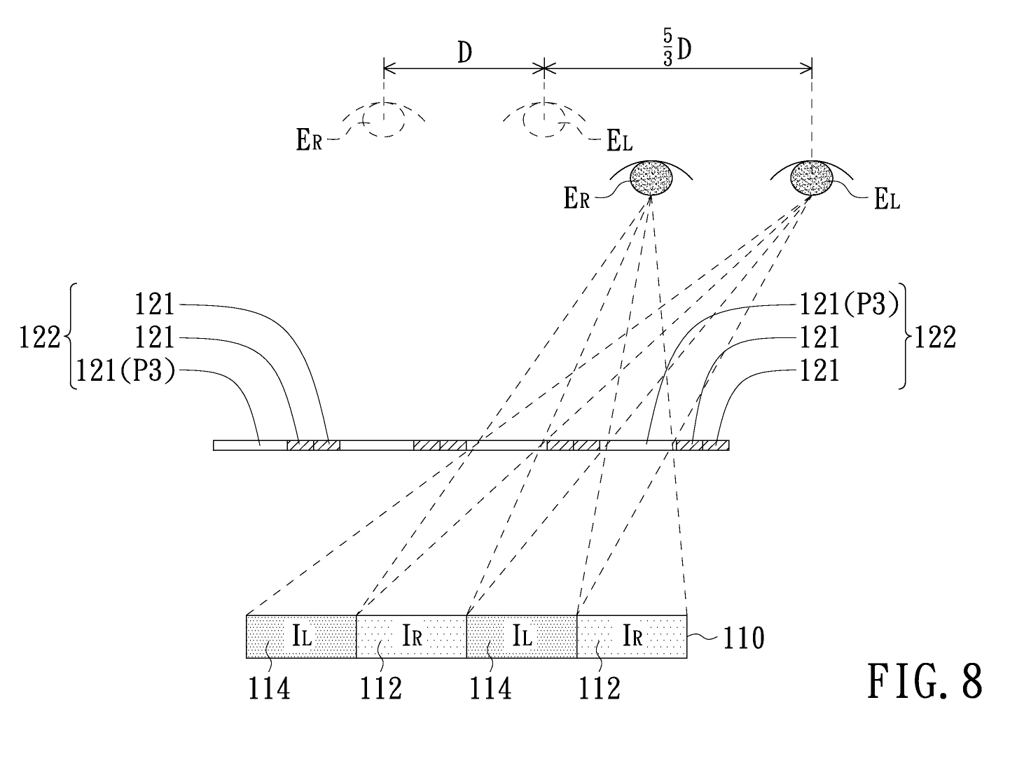

As shown in FIG. 1 and FIG. 8, when the detecting module 140 detects a movement of 5/3D of the viewer toward the right direction in the drawing, the control module 130 can be used to control the grating 121 of each of the barrier unit 122. Specifically, the control module 130 controls the grating 121 at a corresponding position P3 to be in a transparent status and controls the other two gratings 121 to be in an opaque status. At this time, since the viewer's left eye E_{L} sees the images mostly displayed by the second sub-pixel units 114, and the viewer's right eye E_{R} sees the images mostly displayed by the first sub-pixel units 112, the control module 130 is used to control the display panel 110 to display the second image I_{R} by the first sub-pixel units 112 and to display the first image I_{L} by the second sub-pixel units 114. In other words, the images of the first sub-pixel units 112 and the second sub-pixel units 114 are exchanged with each other so that the viewer's left eye E_{L} and right eye E_{R} can respectively see the accurate images, and an accurate three dimensional image is formed in the brain of the viewer. In other words, the position of the transparent grating 121 of the barrier parallax 120 in this embodiment is the same with the parallax barrier 120 in FIG. 5. The difference is that the second sub-pixel units 114 used for providing images for right eye E_{R} is now used for providing images for the left eye E_{L}, and the first sub-pixel units 112 used for providing images for left eye E_{L} is now used for providing images for the right eye E_{R}.

According to the simulating data of the above mentioned embodiments, when the viewer moves his position, the maximum of the crosstalk value of the images is about 99.37%, thus the transparency of the gratings 121 of each of the barrier units 122 need to be changed for reducing the crosstalk value to 32.44%. However, when the viewer is located in some viewing angle, the images viewed by the viewer's left eye E_{L} sees is mostly displayed by the second sub-pixel units 114, and the images viewed by the viewer's right eye E_{R} is mostly displayed by the first sub-pixel units 112. At this time, the images displayed by the first sub-pixel units 112 and the second sub-pixel units 114 must be exchanged with each other for providing the viewer's left eye E_{L} and right eye E_{R} to respectively see the accurate images, thus the crosstalk ratio of the images can be reduced to about 2.94%.

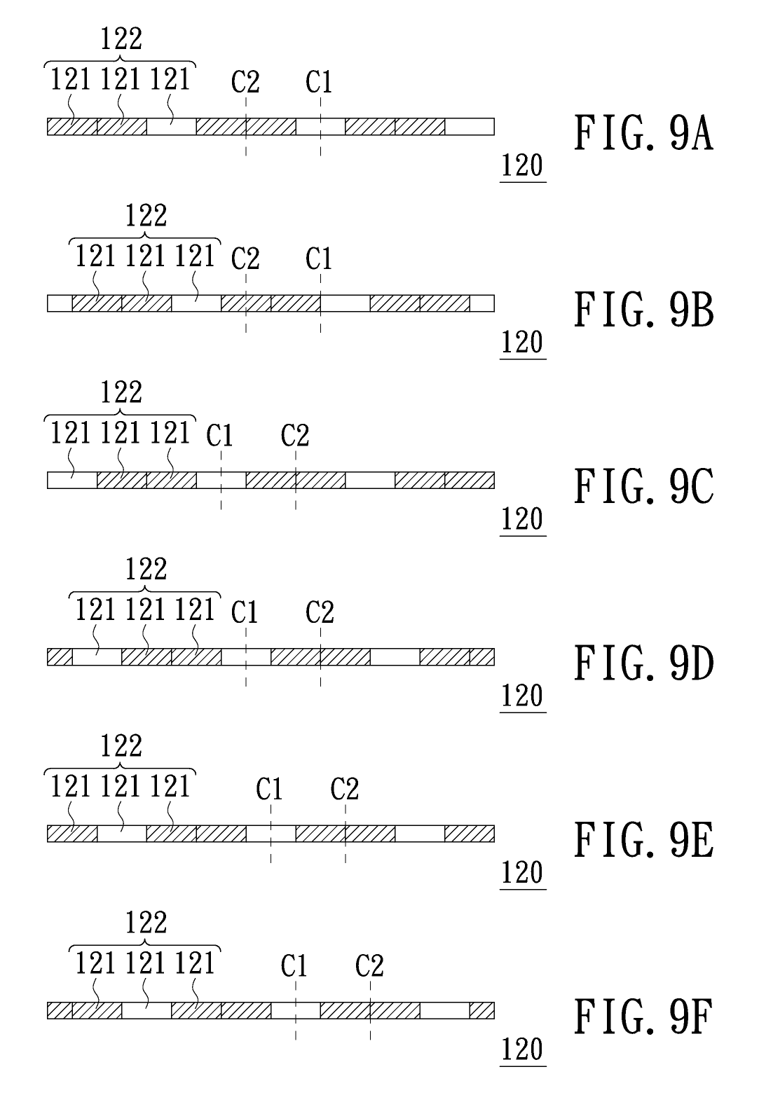

FIG. 9A-9F illustrate equivalent parallax barrier of the above mentioned six embodiments under the condition that the first sub-pixel units show the first image and the second sub-pixel units show the second image. FIG. 9A shows the parallax in FIG. 3. FIG. 9C shows the parallax in FIG. 5. FIG. 9E shows the parallax in FIG. 7. Besides, as mentioned above, the transparent statuses of the gratings 121 of the parallax barrier 120 in FIG. 4, FIG. 6 and FIG. 8 are the same with FIG. 7, FIG. 3 and FIG. 5, but the first sub-pixel units 112 show the second image I_{R}, and the second sub-pixel units 114 show the first image I_{L}.

Accordingly, in the conditions that the first sub-pixel units 112 displays the first image I_{L} and the second sub-pixel units 114 displays the second image I_{R}, the equivalent parallax barrier shown in FIG. 6, that is, the equivalent parallax barrier in FIG. 9D, can be gained by exchanging the geometric center C1 of the transparent grating 121 of the barrier unit 122 with the geometric center C2 of the opaque gratings 121 in FIG. 9A. Similarly, in the above-mentioned conditions, the equivalent parallax barrier shown in FIG. 4, that is, the equivalent parallax barrier in FIG. 9B, can be gained by exchanging the geometric center C1 of the transparent grating 121 of the barrier unit 122 with the geometric center C2 of the opaque gratings 121 in FIG. 9E. Besides, in the same conditions, the equivalent parallax barrier shown in FIG. 8, that is, the equivalent parallax barrier in FIG. 9F, can be gained by exchanging the geometric center C1of the transparent grating 121 of the barrier unit 122 with the geometric center C2 of the opaque gratings 121 in FIG. 9C.

Therefore, in the embodiments in FIG. 3 to FIG. 8, each of the barrier units 122 of the parallax barrier 120 includes three gratings 121, such that only three viewing angles having low crosstalk ratio can be obtained by changing the statues (including transparent or opaque) of the gratings 121. However, not only the transparent statuses of the gratings 121 can be varied, but the images displayed by the first sub-pixel units 112 and the second sub-pixel units 114 can be exchanged in these embodiments, so that there are six available viewing angles with low crosstalk ratio of the autostereoscopic display 100, as shown in FIGS. 3 to 8. In other words, compared to the conventional technologies, the autostereoscopic display of the invention can have double viewing angles with low crosstalk ratio by the same amount of the gratings.

For better understanding the invention, there are more embodiments below to demonstrate the equivalent gratings of the parallax barrier with one transparent grating and four opaque gratings in various viewing angles.

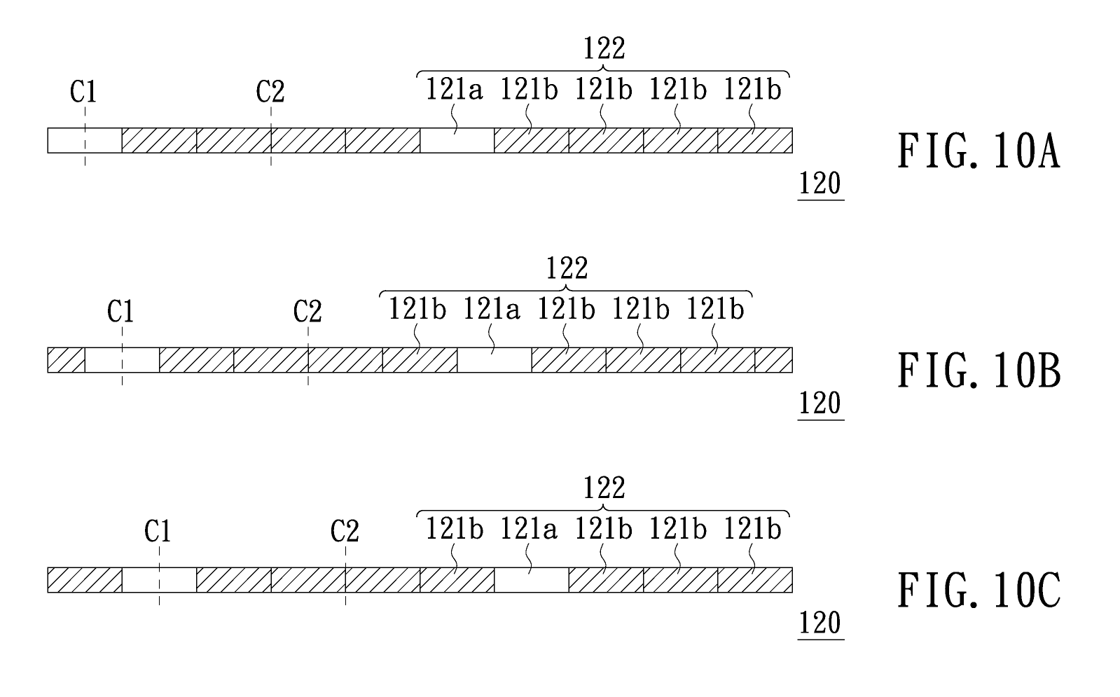

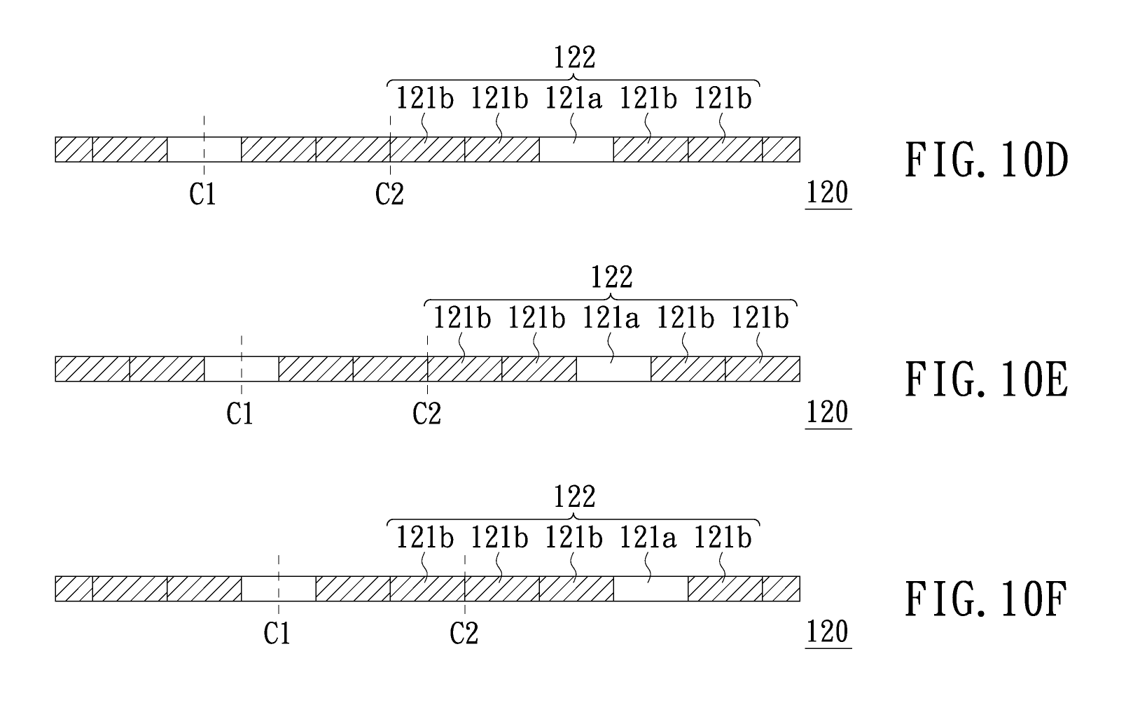

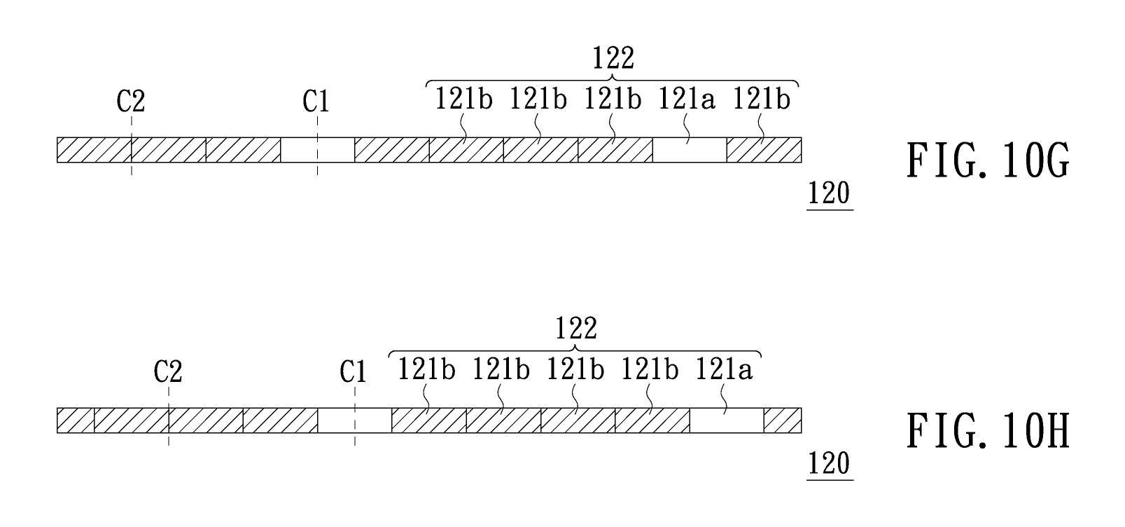

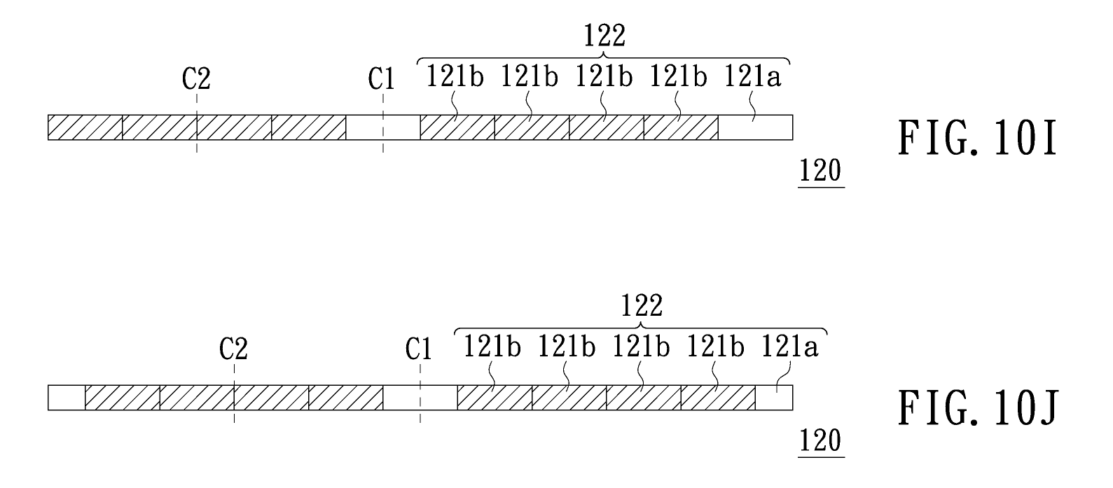

FIG. 10A to 10J are schematic views of the equivalent gratings of the parallax barrier in various viewing angles according to others embodiments of the invention. Refer to FIGS. 10A, 10C, 10E, 10G and 10I, since each of the barrier units 122 of the parallax barrier 120 respectively includes a transparent grating 121a and four opaque grating 121b, there are five arrangements of the gratings of each of the barrier units 122. Besides, the crosstalk ratio of the display device in this embodiment can be reduced by exchanging the images displayed by the pixel units viewed by the left eye and the right eye of a viewer. Therefore, the number of the arrangements of the gratings can be doubled. In this embodiment, there are ten arrangements of the gratings 121 of each of the barrier units 122.

More specifically, the exchange of the images displayed by the pixel units viewed by the left and right eyes incorporating the grating arrangement in FIG. 10A can be obtain the equivalent parallax barrier as shown in FIG. 10F. That is, the equivalent parallax barrier as shown in FIG. 10F can be obtained by exchanging the geometric center C1 of the transparent grating 121a with the geometric center C2 of the opaque gratings 121b in FIG. 10A. Similarly, when the grating arrangement in FIG. 10C is incorporated with exchanging the images displayed by the pixel units viewed by the left and right eye, the equivalent parallax barrier as shown in FIG. 10H can be obtained. When the grating arrangement in FIG. 10E is incorporated with exchanging the images displayed by the pixel units viewed by the left and right eye, the equivalent parallax barrier as shown in FIG. 10J can be obtained. When the grating arrangement in FIG. 10G is incorporated with exchanging the images displayed by the pixel units viewed by the left and right eye, the equivalent parallax barrier as shown in FIG. 10B can be obtained. When the grating arrangement in FIG. 10I is incorporated with exchanging the images displayed by the pixel units viewed by the left and right eye, the equivalent parallax barrier as shown in FIG. 10D can be obtained.

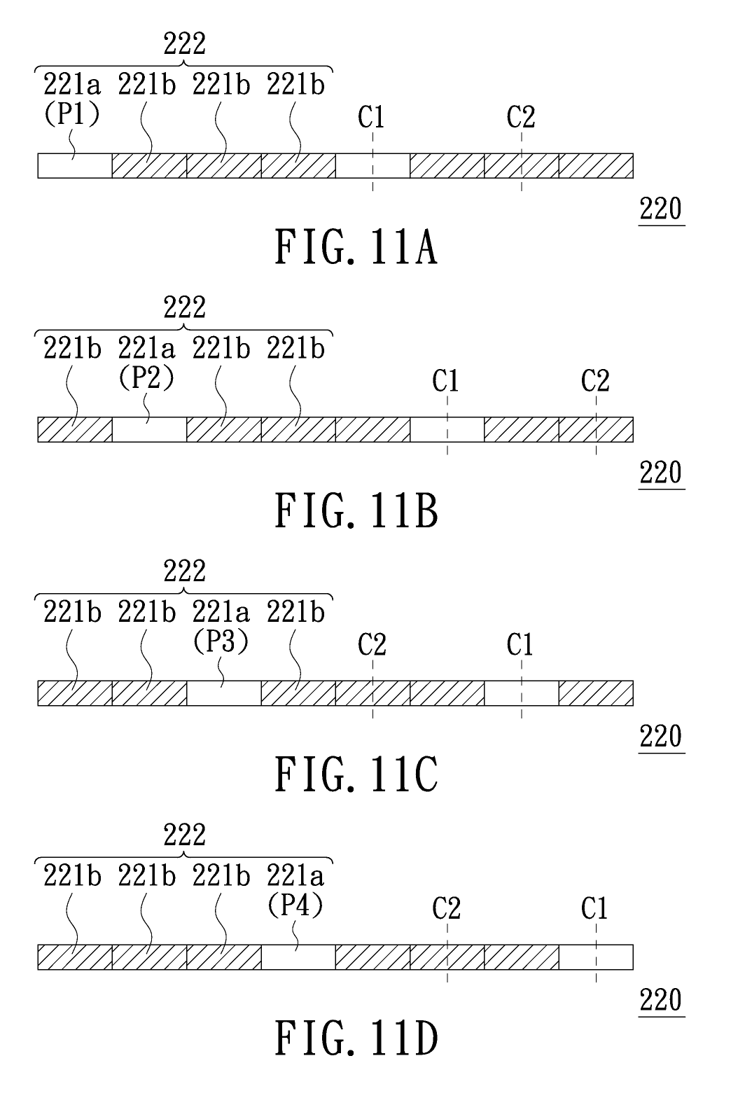

It is to be noted that when the number of the gratings of each of the parallax barrier is even, no extra grating arrangement can be obtained by exchanging the display position of the images to be viewed by the left and right eyes. FIG. 11A to FIG. 11D illustrate several grating arrangements of parallax barriers each having even number of gratings. Refer to FIG. 11A to 11D, each of the barrier units 222 of the parallax barrier 220 of this embodiment includes a transparent grating 221a and three opaque gratings 221b. The transparent grating 221a can be selectively disposed on the first position P1 (as shown in FIG. 11A), the second position P2 (as shown in FIG. 11B), the third position P3 (as shown in FIG. 11C) and the fourth position P4 (as shown in FIG. 11D) depending on the viewing angle of the viewer. Taking FIG. 11D as an example, when the transparent grating 221a is located at the fourth position P4, and the images for the left and the right eyes displayed by the pixels are exchanged, the shown equivalent grating arrangement can be obtained by exchanging the geometric center C1 of the transparent grating 221a with the geometric center C2 of the opaque gratings 221b of each of the barrier units 222. However, the equivalent grating arrangement at this time is the same as shown in FIG. 11B. Therefore, when the number of the gratings of each of the barrier units is even, exchanging the display position of the images for the left eye and the right eye is useless for expanding the viewing angle with low crosstalk.

In summary, the transparent status of the gratings of the parallax barrier of the autostereoscopic display can be adjusted to lower the crosstalk ratio of the three dimensional images viewed by the viewer. Besides, the invention expands the viewing angle of the autostereoscopic display by exchanging the images displayed by the first sub-pixel units and second sub-pixel units without increasing. The number of the opaque gratings of the parallax barrier of the autostereoscopic display. Therefore, the crosstalk ratio of the three dimensional images viewed by the viewer can be lowered without reducing the display brightness of the autostereoscopic display device. Besides, since the number of the gratings of the barrier units in the parallax barrier is not too much, the circuit layout between the parallax barrier and the control module can be simplified, and the manufacturing cost of the autostereoscopic display can be lowered.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An autostereoscopic display comprising:
a display panel with a display surface comprising a plurality of first sub-pixel units and a plurality of second sub-pixel units alternately arranged with each other;
a parallax barrier arranged at a side of the display surface and comprising a plurality of barrier units, each of the barrier units comprising 1st to Nth transparency-adjustable gratings, wherein N is an odd number larger than 1; and
a control module electrically coupled to the display panel and the parallax barrier and configured to control the parallax barrier and images displayed by the first sub-pixel units and the second sub-pixel units.

2. The autostereoscopic display as claim 1, wherein the control module is further configured to control the transparency of the gratings of each of the barrier units to make at least one of the gratings of the each of the barrier units is transparent and the rest of the gratings of the each of the barrier units are opaque, and is further configured to control the first sub-pixel units to selectively display a first image and a second image, and control the second sub-pixel units to selectively display another one of the first image and the second image to provide two three dimension images with different viewing angles.

3. The autostereoscopic display as claim 2, wherein the number N is equal to 3, and one of the 1st to 3rd gratings of each of the barrier units being transparent and the rest two of the 1st to 3rd gratings of each of the barrier units being opaque, and the control module is further configured to control the 1st to 3rd gratings of each of the barrier units for providing different viewing angles through two selected opaque gratings.

4. The autostereoscopic display as claim 3, further comprising a detecting module configured to detecting a position of a viewer and electrically coupled to the control module and the control module is further configured to control at least one of the display panel and the parallax barrier according to the position of the viewer.

5. The autostereoscopic display as claim 4, wherein the widths of each of the gratings of each of the barrier units are equal.

6. The autostereoscopic display as claim 5, wherein the gratings of each of the barrier units are individually electrically coupled to the control module.

7. The autostereoscopic display as claim 1, wherein the number N is equal to 3, and one of the 1st to 3rd gratings of each of the barrier units being transparent and the rest two of the 1st to 3rd gratings of each of the barrier units being opaque, and the control module is further configured to control the 1st to 3rd gratings of each of the barrier units for providing different viewing angles through two selected opaque gratings.

8. The autostereoscopic display as claim 7, further comprising a detecting module configured to detecting a position of a viewer and electrically coupled to the control module and the control module is further configured to control at least one of the display panel and the parallax barrier.

9. The autostereoscopic display as claim 8, wherein the widths of each of the gratings of each of the barrier units are equal.

10. The autostereoscopic display as claim 1, further comprising a detecting module configured to detecting a position of a viewer and electrically coupled to the control module and the control module is further configured to control at least one of the display panel and the parallax barrier.

11. The autostereoscopic display as claim 1, wherein the control module is further configured to control the transparency of the gratings of each of the barrier units to make the grating of the barrier units in a first position being transparent status while the first sub-pixel units displaying a first image and the second sub-pixel units displaying a second image to provide a three dimensional image in a first viewing angle, and the control module is further configured to control the parallax barrier to remain the grating of the barrier units in the first position being transparent while the first sub-pixel units displaying the second image and the second sub-pixel units displaying the first image to provide a three dimensional image in a second viewing angle.

12. The autostereoscopic display as claim 11, wherein the number N is equal to 3, and one of the 1st to 3rd gratings of each of the barrier units being transparent and the rest two of the 1st to 3rd gratings of each of the barrier units being opaque, and the control module is further configured to control the 1st to 3rd gratings of each of the barrier units for providing different viewing angles through two selected opaque gratings.

13. The autostereoscopic display as claim 11, the control module is further configured to control the transparency of the gratings of each of the barrier units to make the grating of the barrier units in the first position being opaque and to make the grating of the barrier units in the second position being transparent while the first sub-pixel units displaying the first image and the second sub-pixel units displaying the second image to provide a three dimensional image in a third viewing angle.

14. A displaying method of an autostereoscopic display, wherein the autostereoscopic display comprises a display panel and a parallax barrier, the display panel comprises a plurality of first sub-pixel units and a plurality of second sub-pixel units arranged, the display panel has a display surface; the parallax barrier is arranged at a side of the display surface and comprises a plurality of barrier units, each of the barrier units includes 1st to Nth number of transparency-adjustable gratings, wherein N is an odd number is larger than 1; the displaying method comprising:
controlling the transparency of the gratings of each of the barrier units for making the grating of each of the barrier units in a first position to be in a transparent status for providing a three dimensional image in a first viewing angle while displaying a first image by the first sub-pixel units and displaying a second image by the second sub-pixel units; and
remaining the grating of each of the barrier units in the first position in the transparent status for providing a three dimensional image in a second viewing angle while displaying the second image by the first sub-pixel units and displaying the first image by the second sub-pixel units.

15. The displaying method as claim 14, further comprising:
controlling the transparency of the gratings of each of the barrier units to make the grating of the barrier units in a second position to be transparent and the grating of the barrier units in the first position to be opaque for providing a three dimensional image in a third viewing angle while displaying the first image by the first sub-pixel units, and displaying the second image by the second sub-pixel units.

16. The displaying method as claim 15, further comprising:
detecting a position of a viewer and providing the three dimensional image of the first viewing angle or the second viewing angle according to the position of the viewer.

17. An autostereoscopic display for providing a three dimensional image in different viewing angle, the autostereoscopic display comprising:
a display panel with a display surface comprising a plurality of first sub-pixel units and a plurality of second sub-pixel units alternately arranged with each other;
a parallax barrier arranged at a side of the display surface and comprising a plurality of barrier units, each of the barrier units including 1st to Nth transparency-adjustable gratings, wherein N is an odd number larger than 1; and
a control module electrically coupled to the display panel and the parallax barrier and configured to control the transparency of the gratings of each of the barrier units to make the grating of the barrier units at a first position to be in a transparent status while the first sub-pixel units displaying a first image and the second sub-pixel units displaying a second image to provide a three dimensional image in a first viewing angle, and the control module is further configured to control the parallax barrier to remain the grating of the barrier units in the first position in the transparent status while the first sub-pixel units displaying the second image and the second sub-pixel units displaying the first image to provide a three dimensional image in a second viewing angle.

18. The autostereoscopic display as claim 17, wherein the number N is equal to 3, and one of the 1st to 3rd gratings of each of the barrier units being transparent and the rest two of the 1st to 3rd gratings of each of the barrier units being opaque, and the control module is further configured to controlling the 1st to 3rd gratings of each of the barrier units for providing different viewing angles through two selected opaque gratings.

19. The autostereoscopic display as claim 18, the control module is further configured to control the transparency of the gratings of each of the barrier units to make the grating of the barrier units in the first position being opaque and to make the grating of the barrier units in the second position being transparent while the first sub-pixel units displaying the first image and the second sub-pixel units displaying the second image to provide a three dimensional image in a third viewing angle.

20. The autostereoscopic display as claim 17, the control module is further configured to control the transparency of the gratings of each of the barrier units to make the grating of the barrier units in the first position being opaque and to make the grating of the barrier units in the second position being transparent while the first sub-pixel units displaying the first image and the second sub-pixel units displaying the second image to provide a three dimensional image in a third viewing angle.
